(19) United States
(12) Patent Application Publication
(10) Pub. No.: US 2024/0368376 A1
(43) Pub. Date: Nov. 7, 2024

(54) STABILIZED POLYMER COMPOSITIONS COMPRISING ORGANIC ACIDS AND DIENE RUBBERS FUNCTIONALIZED WITH UNITS COMPRISING CARBOXYLIC ACID GROUPS

(71) Applicant: ARLANXEO DEUTSCHLAND GMBH, Dormagen (DE)

(72) Inventors: Kilian Nikolaus Richard WUEST, Dormagen (DE); Thomas RUENZI, Duesseldorf (DE)

(73) Assignee: ARLANXEO DEUTSCHLAND GMBH, Dormagen (DE)

(21) Appl. No.: 18/686,542

(22) PCT Filed: Aug. 25, 2022
(86) PCT No.: PCT/EP2022/073655

§ 371 Date: Feb. 26, 2024

(30) Foreign Application Priority Data
Aug. 27, 2021 (EP) 21193500.2

(51) Int. Cl. C08K 5/09; B60C 1/00; C08L 9/00; C08L 9/06

(52) U.S. Cl. CPC C08K 5/09; B60C 1/0016; B60C 1/0025; C08L 9/00; C08L 9/06

(57) ABSTRACT

A polymer composition comprising

(i) at least one first polymer wherein the first polymer is a functionalized diene polymer comprising at least one functional unit having at least one carboxylic acid group or a salt thereof, wherein the functional unit is selected from terminal groups, side groups and combinations thereof, and preferably is a terminal group;

(ii) at least one organic acid according to the general formula (1):

Ry-(Acg)ₙ (1),

(iii), optionally, at least one second polymer,

wherein the polymer composition has a total amount of first and second polymer of at least 90% by weight, or at least 95% by weight, based on the total weight of the composition which is 100% and wherein the amount of the at least one first polymer is at least 10% by weight, and wherein the first or the second polymer or both contain from 0 to 100 parts of extender oil per 100 parts of polymer and wherein the amount of polymer indicated by weight percent includes the amount of extender oil when present, and wherein in formula (1)

Acg represents an acid group selected from —COOH, —SO₃H, —OSO₃H, —PO₃H₂, —OPO₃H₂ and salts thereof and combinations thereof;

n represents an integer from 1 to 10.000;

Ry represents an aromatic or aliphatic, linear, cyclic or branched hydrocarbon or heterohydrocarbon residue having a valency corresponding to n, wherein the heterohydrocarbon residue is a hydrocarbon residue that comprises additionally one or more heteroatoms selected from N, S, Si, O, F, Cl, Br and combinations thereof, and, in case Acg is COOH, Ry can also represent H,

and wherein the first functionalized diene polymer is a homopolymer of a conjugated diene or a copolymer of at least one conjugated diene and wherein the at least one conjugated diene comprises butadiene, isoprene, isoprene, 1,3-pentadiene, 2,3-dimethylbutadiene, 1-phenyl-1,3-butadiene, 1,3-hexadiene, myrcene, ocimenes and farnesene, preferably butadiene and isoprene, more preferably butadiene.

Also provided are methods of making such compositions and articles made with such compositions.

### FIELD

The present disclosure relates to compositions comprising organic acids or salts thereof and diene rubbers functionalized with groups containing carboxylic acid groups or salts thereof, their production and use.

### BACKGROUND

Diene rubbers are used in many different applications. They are typically combined with one or more filler to produce rubber compounds which are then shaped into articles or combined with other ingredients to produce articles. A major application of diene rubbers includes tires or components of tires such as tire treads. Typical diene rubbers are homopolymers of dienes or copolymers of at least one diene monomer.

The interactions of rubbers with fillers that are used in making the rubber compounds can be improved by introducing functional end groups to the polymer. Therefore, various diene rubbers with functionalized with polar end groups have been developed. Diene rubbers with functionalized with groups containing carboxylic acid groups have been found to lead to improved compounds, in particular for making tires, as described, for example, in U.S. patent applications US2016/0075809 A1 and US2016/0083495 A1 (Steinhauser and Gross) and in international patent application WO2021/009154 (Steinhauser). However, it was found that the Mooney viscosity of polymers functionalized with units containing carboxylic acid groups can change significantly upon storage while their molecular weight distribution determined by SEC remains unchanged. Since the Mooney viscosity is related to the molecular weight of a polymer, the instability of the Mooney viscosity can be attributed to the presence of the functional groups of the polymers. The instability of the Mooney viscosity of the functionalized polymers, however, presents a quality control problem because the Mooney viscosity is typically used in the industry as a specification for the molecular weight of the polymer because the Mooney viscosity can be measured more easily. However, polymers showing instable Mooney viscosities can no longer be specified reliably by their Mooney viscosity. Therefore, there was a need to provide compositions of polymers functionalized with units containing carboxylic acids that have a more stable Mooney viscosity.

### SUMMARY

It has now been found that adding an organic acid to diene rubbers having functional units comprising at least one carboxylic acid groups can stabilize the Mooney viscosity of such rubbers. The addition can be made to solutions or solid compositions. Adding the organic acid to polymer solutions may also facilitate the work up of the polymers because also solution viscosity of the polymer solutions can be reduced.

In one aspect there is provided a polymer composition comprising
(i) at least one first polymer wherein the first polymer is a functionalized diene polymer comprising at least one functional unit having at least one carboxylic acid group or a salt thereof, wherein the functional unit is selected from terminal groups, side groups and combinations thereof, and preferably is a terminal group;
(ii) at least one organic acid according to the general formula (1):

Ry-(Acg)ₙ (1),
(iii), optionally, at least one second polymer,
   wherein the polymer composition has a total amount of first and second polymer of at least 90% by weight, or at least 95% by weight, based on the total weight of the composition which is 100% and wherein the amount of the at least one first polymer is at least 10% by weight, preferably at least 75% by weight and more preferably at least 95% by weight, and wherein the first or the second polymer or both contain from 0 to 100 parts of extender oil per 100 parts of polymer and wherein the amount of polymer indicated by weight percent includes the amount of extender oil if present, and wherein in formula (1)
   Acg represents an acid group selected from —COOH, —SO₃H, —OSO₃H, —PO₃H₂, —OPO₃H₂ and salts thereof and combinations thereof;
   n represents an integer from 1 to 10.000;
   Ry represents an aromatic or aliphatic, preferably saturated, linear, cyclic or branched hydrocarbon or heterohydrocarbon residue having a valency corresponding to n, wherein the heterohydrocarbon residue is a hydrocarbon residue that comprises additionally one or more heteroatoms selected from N, S, Si, O, F, Cl, Br and combinations thereof, and, in case Acg is COOH, Ry can also represent H,
   and wherein the first functionalized diene polymer is a homopolymer of a conjugated diene or a copolymer of at least one conjugated diene and wherein the at least one conjugated diene is selected from butadiene.

In another aspect there is provided a process of producing the polymer composition comprising adding the organic acid to the first polymer wherein the first polymer is present either a) in solution in the presence of a solvent or b) in solid form, and wherein in case of a) the process, optionally, further comprises removing the solvent.

In a further aspect there is provided a process for producing a rubber compound comprising combining the polymer composition with at least one filler, at least one curing agent capable of curing the at least first polymer or a combination thereof.

In yet a further aspect there is provided an article obtained from curing a composition comprising the rubber compound.

### DETAILED DESCRIPTION

In the following description contrary to the term “consisting of”, the terms “comprising”, “containing”, “including”, “having” are not intended to exclude the presence of any additional component, step or procedure.

In the following description norms may be used. If not indicated otherwise, the norms are used in the version that was in force on Mar. 1, 2020. If no version was in force at that date because, for example, the norm has expired, the version is referred to that was in force at a date that is closest to Mar. 1, 2020.

In the following description the amounts of ingredients of a composition or polymer may be indicated interchangeably by “weight percent”, “wt. %” or “% by weight”. The terms “weight percent”, “wt. %” or “% by weight” are based on the total weight of the composition or polymer, respectively, which is 100% unless indicated otherwise.

The term “phr” means parts per hundred parts of rubber, i.e. the weight percentage based on the total amount of rubber which is set to 100%.

Ranges identified in this disclosure include and disclose all values between the endpoints of the range and also include the end points unless stated otherwise.

The term “substituted” is used to describe hydrocarbon-containing organic compounds where at least one hydrogen atom has been replaced by a chemical entity other than a hydrogen. That chemical entity is referred to herein interchangeably as “substituent”, “residue” or “radical”. For example, the term “a methyl group substituted by fluorine” refers to a fluorinated methyl group and includes the groups —CF₃, —CHF₂ and —CH₂F. The term “unsubstituted” is meant to describe a hydrocarbon-containing organic compound of which none of its hydrogen atoms have been replaced. For example, the term “unsubstituted methyl residue” refers to a methyl, i.e. —CH₃.

### Organic Acids

Organic acids according to the present disclosure contain at least one acid group selected from carboxylic acid, sulfonic acid, sulfuric acid, sulfate, phosphoric acid, phosphonic acid and salts thereof and combinations thereof. The organic acid may be a monoacid or a polyacid. The organic acids may comprise, for example, from 1 to 10000 organic acid groups, or from 1 to 10 acid groups, or from 1 to 4 acid groups or from 1 to 2 acid groups, or they may have only one organic acid group.

The organic acids contain at least one organic residue. The organic residue may be aromatic, aliphatic, linear, cyclic or branched, saturated or unsaturated. The organic residue may be a hydrocarbon residue or a heterohydrocarbon residue. The term “heterohydrocarbon residue” as used herein means a hydrocarbon residue that in addition to hydrogen and carbon atoms contains other atoms, preferably selected from selected from N, S, Si, O, F, Cl, Br and combinations thereof. Such heteroatoms may be part of functional groups, like hydroxy groups, carbonyl groups, thiol groups, (poly)siloxane groups, (poly)silane groups, or they may be part of the carbon chain and interrupting it, for example as ether atoms —O—) or thio ether atoms (—S—). The organic acid or organic polyacid may have a molecular weight (without the weight of the cations) of up to 100,000 g/mole. In one embodiment of the present disclosure the organic acid has a molecular weight (without the weight of the cations) of less than 10.000 g/mole.

The organic acid according to the present disclosure can be represented by the general formula (1):

Ry-(Acg)ₙ (1),

wherein
Acg represents an acid group selected from —COOH, —SO₃H, —OSO₃H; —PO₃H₂, —OPO₃H₂, salts thereof and combinations thereof;
n represents an integer from 1 to 10.000, preferably 1 to 10, more preferably 1 to 4 or 1, 2 or 3, most preferably 1 or 2;
Ry represents an aromatic or an aliphatic, linear cyclic or branched hydrocarbon or heterohydrocarbon residue having a valency corresponding to n, wherein the heterohydrocarbon residue is a hydrocarbon residue that comprises additionally one or more heteroatoms selected from N, S, Si, O, F, Cl, Br and combinations thereof

Preferably Ry has from 5 to 5000, preferably 5 to 50, more preferably 5 to 35 carbon atoms. For example, the organic acid may have 5, 6, 7, 8, 9, 10, 11, 12, 13, 14, 15, 16, 17, 18, 19, 20, 21, 22, 23, 24 or 25 carbon atoms. Ry has a valency corresponding to n. In one embodiment of the present disclosure Ry represents a residue, preferably an aliphatic residue, more preferably a hydrocarbon residue, having from 1 to 50 carbon atoms or the organic acid is formic acid or a salt thereof.

Preferably, the organic acid is a carboxylic acid and Acg represents a carboxylic acid group or a salt thereof. In a preferred embodiment of the present disclosure the organic acid is a carboxylic acid or a salt thereof and n represents an integer from 1 to 1.000, preferably 1, 2, 3, 4, 5, 6, 7, 8, 9 or 10, more preferably n represents 1 or 2, more preferably n represents 1.

Preferably Ry is aliphatic and may be saturated or unsaturated, cyclic, linear or branched. More preferably Ry is a saturated, aliphatic hydrocarbon residue that, optionally, may contain one or more catenary oxygen atoms, i.e., optionally, Ry may be a hydrocarbon ether or a hydrocarbon polyether.

In one embodiment the organic acid is a polymeric acid or salt thereof including but not limited to polyacrylates, polyacrylate-containing copolymers or compounds having one or more polyacrylate unit. The polymeric acids or polyacids may have a molecular weight of from 1.000 g/mole to 100.000 g/mol (excluding the weight of cations if present), or from 1.000 to 5000 g/mol.

In one embodiment the organic acid is not polymeric. In one embodiment the organic acid has a molecular weight (excluding the weight of any cations) of less than 1.000 g/mol, preferably less than 500 g/mol.

Preferably, the organic acid is soluble in the solvent that is or was used for the polymerization reaction. Preferably, the organic acid is not halogenated. Examples of suitable organic acids include but are not limited to malonic acid, adipinic acid, formic acid, pentanoic acid, xexanoic acid, acetic acid, versatic acid and fatty acids including, but not limited to, caprylic acid (C9-COOH), capric acid, lauric acid, (C11-COOH), myristic acid, palmitic acid, stearic acid (C19-COOH), arachidic acid, behenic acid, lignoceric acid, cerotic acid, salts thereof and combinations thereof. Fatty acids also include unsaturated fatty acids including myristoleic acid, palmitoleic acid, sapienic acid, oleic acid, elaidic acid, vaccenic acid, linoleic acid, linoelaidic acid, arachidonic acid, erucic acid, docosahexaenoic acid, eicosapentaenoic and combinations thereof, although unsaturated fatty acids are less preferred.

The organic acids may be used in amounts effective to reduce the solution viscosity of polymer solutions and/or to reduce the Mooney viscosity of the polymer. Adding organic acids in molar excess to carboxylic acid groups or salts thereof of the first polymer may not be detrimental but may not be necessary and can be avoided. The optimum amounts may depend on the type and amount of carboxylic acid group containing units of the polymer and the type of organic acid and may be identified by routine optimization experiments. Typical amounts of organic acid in the polymer compositions according to the present disclosure include from 0.01 wt % up to 10 wt % based on the total weight of the composition, or from 0.1% to 9% by weight or from 1.1% by weight up to 7.5% by weight.

### First Polymers

The first polymers according to the present disclosure are functionalized polymers and they comprise at least one functional unit. The functional unit comprises at least one carboxylic acid group or a salt thereof. The functional unit can be selected from terminal groups (alpha end groups or omega end groups or both), side groups and combinations thereof. In one embodiment the first polymer comprises at least one such functional unit at the chain end, i.e., at the alpha position (head) or at the omega position (tail) of the polymer or at both positions wherein the functional units may be identical or different. Preferably, the polymer comprises the functional unit at its chain end, i.e., at the omega position of the polymer and the functional unit comprises a terminal unit. The first polymer may or may not comprise, in addition, one or more other functional groups other than the functional units having a carboxylic acid group or a salt thereof.

The first polymer is a rubber, preferably a diene polymer. Diene rubbers obtained by a polymerization reaction comprising at least one diene as monomer, preferably at least one conjugated diene as monomer. Preferably the first polymer is a homopolymer or a copolymer of at least one conjugated diene. Preferred conjugated dienes include but are not limited to 1,3-butadiene, isoprene, 1,3-pentadiene, 2,3-dimethylbutadiene, 1-phenyl-1,3-butadiene, 1,3-hexadiene, myrcene, ocimenes and/or farnesenes. 1,3-Butadiene and/or isoprene are particularly preferred. The conjugated dienes also include substituted conjugated dienes, where one or more hydrogen atoms of the diene have been replaced by groups containing one or more heteroatoms selected from Si, N, O, H, Cl, F, Br, S and combinations thereof or functional groups containing one or more heteroatoms, for example functional groups having one or more heteroatoms selected from Si, N, O, H, Cl, F, Br, S and combinations. Examples of functional groups include but are not limited to hydroxy, thiol, thioether, ether, halogen and units having one or more carboxylic acid groups or salt thereof and combinations thereof. Such functionalized conjugated dienes are preferably copolymerized with one or more of the conjugated dienes described above. In one embodiment the conjugated diene includes a conjugated diene that contains a unit having a carboxylic acid group or a group containing a unit that can be converted into a carboxylic acid group.

In one embodiment of the present disclosure the first polymer is a polybutadiene homopolymer, more preferably a 1,3-butadiene homopolymer. In another embodiment of the present disclosure the first polymer is a 1,3-butadiene-copolymer.

In another embodiment of the present disclosure the first polymer is a copolymer of a conjugated diene, preferably a copolymer comprising units derived from one or more conjugated diene as described above and/or one or more vinyl aromatic monomer, and, optionally, one or more units derived from one or more other comonomers. Examples of vinylaromatic monomers include, but are not limited to, styrene, ortho-methyl styrene, meta-methyl styrene, para-methyl styrene, para-tertbutyl styrene, vinyl naphthalene, divinyl benzene, trivinyl benzene, divinyl naphthalene and combinations thereof. Styrene is particularly preferred. The vinylaromatic monomers also include substituted vinyl aromatic monomers where one or more hydrogen atoms of the vinyl aromatic monomer have been replaced by a heteroatom or groups having one or more heteroatoms, preferably selected from Si, N, O, H, Cl, F, Br, S and combinations thereof. Substituted monomers also include vinyl aromatic monomers having one or more functional groups with one or more heteroatoms or units containing at least one functional group with one or more heteroatom. Preferably, the heteroatoms are selected from Si, N, O, H, Cl, F, Br, S and combinations thereof. Examples of functional groups include but are not limited to hydroxy, thiol, thioether, ether, halogen carboxylic acid groups or salt thereof and combinations thereof. Such functionalized conjugated monomers are preferably copolymerized with one or more of the vinylaromatic monomers described above.

In a preferred embodiment the first polymer according to the present disclosure comprises repeating units derived from 1,3-butadiene and styrene.

The first polymers according to the present disclosure preferably have an average molecular weight (number average, Mn) of 10,000 to 2,000,000 g/mol, preferably of 100,000 to 1,000,000 g/mol.

Preferably, the first polymers according to the present disclosure have a glass transition temperature (Tg) of from about −110° C. to about +20° C., preferably of from about −110° C. to about 0° C.

Preferably, the first polymers according to the present disclosure have a Mooney viscosity [ML 1+4(100° C.)] of from about 10 to about 200, preferably from about 30 to about 150 Mooney units or from 41 to 140 Mooney units.

The polymers typically have a dispersity from about 1.03 to about 3.5.

The first polymers can be prepared by methods known in the art. Preferably the polymers can be obtained by a process comprising an anionic solution polymerization or a polymerization using one or more coordination catalysts. The polymerization may be carried out in solution or in the gas phase. Coordination catalysts include Ziegler-Natta catalysts or monometallic catalyst systems. Preferred coordination catalysts are those based on Ni, Co, Ti, Zr, Nd, V, Cr, Mo, W or Fe.

Preferably the polymerization reaction comprises an anionic solution polymerization. Initiators for anionic solution polymerization include organometals, preferably based on alkali or alkaline earth metals. Examples include but are not limited to methyllithium, ethyllithium, isopropyllithium, n-butyllithium, sec-butyllithium, pentyllithium, n-hexyllithium, cyclohexyllithium, octyllithium, decyl-lithium, 2-(6-lithio-n-hexoxy)tetrahydropyran, 3-(tert-butyldimethylsiloxy)-1-propyllithium, phenyllithium, 4-butylphenyllithium, 1-naphthyllithium, p-toluyllithium and allyllithium compounds, derived from tertiary N-allylamines such as [1-(dimethylamino)-2-propenyl]lithium, [1-[bis(phenylmethyl)amino]-2-propenyl]lithium, [1-(diphenylamino)-2-propenyl]lithium, [1-(1-pyrrolidinyl)-2-propenyl]lithium, lithium amides of secondary amines such as lithium pyrrolidide, lithium piperidide, lithium hexamethylene imide, lithium 1-methyl imidazolidide, lithium 1-methyl piperazide, lithium morpholide, lithium dicyclohexylamide, lithium dibenzyl amide, lithium diphenyl amide. The allyllithium compounds and the lithium amides can also be prepared in situ by reacting an organolithium compound with the respective tertiary N-allylamines or with the respective secondary amines. Di- and polyfunctional organolithium compounds can also be used, for example 1,4-dilithiobutane, dilithium piperazide. Preferably n-butyllithium, sec-butyllithium or a combination thereof are used.

Randomizers and control agents as known in the art can be used in the polymerization for controlling the structure of the polymer. Such agents include, for example, diethyl ether, di-n-propylether, diisopropyl ether, di-n-butylether, ethylene glycol dimethyl ether, ethylene glycol diethyl ether, ethylene glycol di-n-butyl ether, ethylene glycol di-tert-butyl ether, diethylene glycol dimethyl ether, diethylene glycol diethyl ether, diethylene glycol di-n-butyl ether, diethylene glycol di-tert-butyl ether, 2-(2-ethoxyethoxy)-2-methyl-propane, triethylene glycol dimethyl ether, tetrahydrofuran, ethyltetrahydrofurfuryl ether, hexyltetrahydrofurfuryl ether, 2,2-bis(2-tetrahydrofuryl)propane, dioxane, trimethylamine, triethylamine, N,N,N′,N′-tetramethyl-ethylenediamine, N-methylmorpholine, N-ethylmorpholine, 1,2-dipiperi-dinoethane, 1,2-dipyrrolidinoethane, 1,2-dimorpholinoethane, potassium and sodium salts of alcohols, phenols, carboxylic acids, sulphonic acids and combinations thereof.

Preferred solvents for the solution polymerization include inert aprotic solvents, for example aliphatic hydrocarbons. Specific examples include, but are not limited to, butanes, pentanes, hexanes, heptanes, octanes, decanes and cyclopentane, methylcyclopentane, cyclohexane, methylcyclohexane, ethylcyclohexane, 1,4-dimethylcyclohexane and combinations thereof and including isomers thereof. Further examples include alkenes such as 1-butene or aromatic hydrocarbons such as benzene, toluene, ethylbenzene, xylene, diethylbenzene or propylbenzene and combinations thereof. These solvents can be used individually or as mixtures. Preferred solvents are cyclohexane, methylcyclopentane and n-hexane. The solvents may also be mixed with polar solvents if appropriate.

The polymerization can be carried out by first introducing the monomers and the solvent and then starting the polymerization by adding the initiator or catalyst. The polymerization may also be carried out in a feed process where the polymerization reactor is filled by adding monomers and solvents. The initiator or catalyst are introduced or added with the monomers and solvent. Variations may be applied, such as introducing the solvent in the reactor, adding initiator or catalyst followed by adding the monomers. The polymerization can be carried out in a continuous mode or batchwise. Further monomer and solvent may be added during or at the end of the polymerization.

The polymerization time can vary from a few minutes to several hours. The polymerization is usually carried out within a period of 10 minutes to 8 hours, preferably from 20 minutes to 4 hours. The polymerization can be carried out at normal pressure or at elevated pressure (for example, from 1 to 10 bar) or at reduced pressure. Typical reaction temperatures include temperatures between 35° C. and 130° C.

The preparation of the end-group functionalized polymers according to the present disclosure further involves the addition of at least one functionalization agent and may be followed by the addition of at least one further functionalization agent. The addition of the first or second functionalization agent can be part of a continuous process. However, the process can be carried out batchwise also, for example by stopping the process after the addition of the first functionalization process and starting the process again before adding the second functionalization agent-if needed.

The first polymer is functionalized by the appropriate functionalization agents to have at least one functional unit comprising at least one carboxylic group or salt thereof. The functional unit can be represented by formula (2):

-Rx-COOX (2).

In formula (2) -COOX represents a carboxylic acid group or a salt thereof. In case of a carboxylic acid group X represents H. In case of a salt thereof X represents a cation, which may be organic or inorganic. Typical cations include the cation of Li, Na, K, Mg, Ca, Zn, Fe, Co, Ni, Al, Nd, Ti, Sn, Si, Zr, V, Mo or W.

Rx represents a divalent spacer group connecting the carboxylic acid group and the polymer either as a side chain or as end group or both. In its simplest form Rx represents a chemical bond. In one embodiment of the present disclosure the spacer group Rx comprises at least a silane, a polysilane, a siloxane, a polysiloxane. In one embodiment Rx further comprises at least one unit selected from —S—, —N(Si(alkyl)₃)- , or -NR- wherein “alkyl” represents, independently, a C1 to C6 alkyl and R represents, independently H or a C1 to C6 alkyl.

In one embodiment of the present disclosure the spacer group comprises one or more unit selected from —C(═O)-NR- where R represents a saturated or unsaturated organic radical with 1 to 40 carbon atoms and which may contain one or more heteroatoms, preferably selected— independently of one another—from the group consisting of O, N, S and Si; preferably R3 is an alkyl and more preferably R3 is —CH₃.

Functional units having at least carboxylic acid groups or salts thereof can be introduced to the polymers by methods known in the art. Methods for introducing carboxy groups along the polymer chain of diene rubbers produced in solution are known and described for example in DE 26 531 44 A1, EP 1 000 971 A1, EP 1 050 545 A1, WO 2009/034001 A1. The introduction of carboxy groups at the chain ends of diene rubbers is also described, for example in U.S. Pat. No. 3,242,129 by reacting the anionic polymer chain ends with CO₂. Polymers with silane-containing carboxylic acid end groups can be prepared, for example, according to methods as described, in U.S. patent applications US2016/0075809 A1 and US2016/0083495 (Steinhauser and Gross) each incorporated by reference in its entirety. Polymers with carboxylic end groups and spacers containing at least one unit —C(═O)-NR- where R represents a saturated or unsaturated organic radical with 1 to 40 carbon atoms and which may contain one or more heteroatoms, preferably selected—independently of one another—from the group consisting of O, N, S and Si; may be prepared by reaction of reactive polymer chains, preferably anionic chain ends, first with an imidazolidinone followed by reaction with a cyclic carboxylic acid anhydride as described, for example, in international patent application WO2021/009154 (Steinhauser) incorporated herein by reference in its entirety.

In a preferred embodiment of the present disclosure the unit comprising the carboxylic acid group or a salt thereof comprises at least one silane, siloxane, polysilane, polysiloxane or a combination thereof. In one embodiment the spacer group Rx comprises additionally at least one unit selected from —S—, —N(Si(alkyl)₃)-, -NR- wherein “alkyl” represents, independently, a C1 to C6 alkyl and R represents, independently H or a C1 to C6 alkyl.

Preferably the first polymer comprises a functional unit having a spacer comprising or consisting of a unit represented by formula (2A):

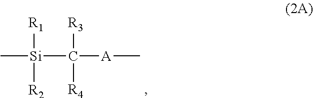

formula (2B):

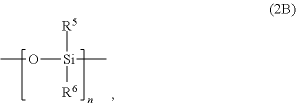

or a combination thereof. Preferably the spacer comprises a combination of one or more units according to formula (2A) and (2B) and preferably a unit of formula (2B) is placed between the polymer and formula (2A) and more preferably such functional group is a terminal group.

In formula (2A) and (2B)

R¹, R² are the same or different and are each selected from H or a residue having from 1 to 20 carbon atoms, preferably alkyl, alkoxy, cycloalkyl, cycloalkoxy, aryl, aryloxy, alkaryl, alkaryloxy, aralkyl, or aralkoxy radicals;
R³, R⁴ are the same or different and are each selected from H or a residue having from 1 to 20 carbon atoms, preferably alkyl, cycloalkyl, aryl, alkaryl or aralkyl radical,
R⁵, R⁶ are the same or different and are each selected from H, a residue having from 1 to 20 carbon atoms, preferably selected from alkyl, cycloalkyl, aryl, alkaryl or aralkyl radical, wherein the radical may contain one or more heteroatoms, preferably O, N, S or Si,
A is a divalent organic radical, preferably having from 1 to 26 carbon atoms, and which may, in addition to hydrogen atoms, comprise heteroatoms preferably selected from O, N, S, Si, and n is an integer of 1 to 20, preferably 3, 4, 5 or 6.

Preferably R¹, R² are the same or different and are each H, (C₁-C₂₄)-alkyl, (C₁-C₂₄)-alkoxy, (C₃-C₂₄)-cycloalkyl, (C₃-C₂₄)-cycloalkoxy, (C₆-C₂₄)-aryl, (C₆-C₂₄)-aryloxy, (C₆-C₂₄)-alkaryl, (C₆-C₂₄)-alkaryloxy, (C₆-C₂₄)-aralkyl or (C₆-C₂₄)-aralkoxy radical which, optionally, may contain one or more heteroatoms, preferably O, N, S or Si, and

R³, R⁴ are the same or different and are each an H, (C₁-C₂₄)-alkyl, (C₃-C₂₄)-cycloalkyl, (C₆-C₂₄)-aryl, (C₆-C₂₄)-alkaryl or (C₆-C₂₄)-aralkyl radical, optionally containing one or more heteroatoms, preferably O, N, S or Si.

In one embodiment of the present disclosure A is represented by:

-Xn-(CY1H)m-(CY2Y3)o-(CY1H)p-

where
n is 1 or 0, m is 1, 2, 3 or 4, o is 0, 1 or 2, p is 0, 1 or 2,
X is O, S, NR, where R is H or C1-C3 alkyl or X is N(Si(alkyl)₃), wherein each “alkyl” independently from each other represents a C1 to C6 alkyl, -oxyalkyl or alkoxy;
Y1 is H or C1-C3 alkyl, Y2 is H or C1-C3 alkyl, Y3 is H or C1-C3 alkyl, preferably at least one of Y2 and Y3 is H.

Specific, non-limiting-examples of A include:

—CH₂—; —CH₂CH₂—; —CH₂CH₂CH₂—; —C(CH₃)—CH₂—; —CH₂—C(CH₃)—CH—; —CH(CH₃)—C(CH₃)H—; —CH(CH₃)—CH₂—C(CH₃)H—; —CH₂—C(CH₃)H—C(CH₃)H—; —CH(CH₃)—C(CH₃)H—CH₂—; —O—CH₂—; —O—CH₂CH₂—; —O—CH₂CH₂—CH₂—; —O—C(CH₃)H—; —O—CH₂CH₂—; —O—C(CH₃)H—CH₂—; —O—CH₂—C(CH₃)H—; —O—CH₂—C(CH₃)H—CH₂—; —O—CH₂CH₂—C(CH₃)H—; —O—C(CH₃)H—CH₂—CH₂—; —S—CH₂—; —S—CH₂CH₂—; —S—CH₂CH₂—CH₂—; —S—C(CH₃)H—; —S—CH₂CH₂—; —S—C(CH₃)H—CH₂—; —S—CH₂—C(CH₃)H—; —S—CH₂—C(CH₃)H—CH₂—; —S—CH₂CH₂—C(CH₃)H—; —S—C(CH₃)H—CH₂—CH₂—;
—NH—CH₂—; —NH—CH₂CH₂—; —NH—CH₂CH₂—CH₂—; —NH—C(CH₃)H—CH₂—; —NH—CH₂—C(CH₃)H—; —NH—CH₂—C(CH₃)H—CH₂—; —NH—CH₂CH₂—C(CH₃)H—; —NH—C(CH₃)H—CH₂—CH₂—; —N(CH₃)—CH₂—; —N(CH₃)—CH₂—; —N(CH₃)—CH₂CH₂—; —N(CH₃)—CH₂CH₂—CH₂—; —N(CH₃)—C(CH₃)H—CH₂—; —N(CH₃)—CH₂—C(CH₃)H—; —N(CH₃)—CH₂—C(CH₃)H—CH₂—; —N(CH₃)—CH₂CH₂—C(CH₃)H—; —N(CH₃)—C(CH₃)H—CH₂—CH₂—; N(Si(alkyl)₃)-CH₂—; —N(Si(alkyl)₃)-CH₂CH₂—; N(Si(alkyl)₃)-CH₂CH₂CH₂—; —N(Si(alkyl)₃)-C(CH₃)H—; —N(Si(alkyl)₃)-CH₂CH₂—; —N(Si(alkyl)₃)-C(CH₃)H—CH₂—; —N(Si(alkyl)₃)-CH₂—C(CH₃)H—; —N(Si(alkyl)₃)—CH₂—C(CH₃)H—CH₂—; —N(Si(alkyl)₃)-CH₂CH₂—C(CH₃)H—; —N(Si(alkyl)₃)-C(CH₃)H—CH₂—CH₂—.

Such polymers may be obtained by a reaction of an anionic polymer chain with one or more silolactones according to formula (III).

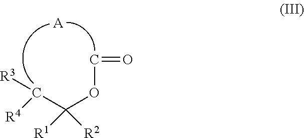

where A, R1, R2, R3, R4 and n have the same meaning as described above.

The reaction may be preceded by a reaction of the reactive anionic polymer with a reagent which leads to polymers having silanol or silanolate end groups. In a second step the polymers having silanol or silanolate end groups are allowed to react with compounds of the formula (III). Preferably reagents are used in the first step that can lead directly or indirectly (for example via a subsequent hydrolysis of Si-Cl groups) to silanol or silanolate end groups, wherein silanolate end groups are preferred. In one embodiment the reagent used in the first step comprises a cyclosiloxanes, more preferably a cyclosiloxane of according to formula (IV):

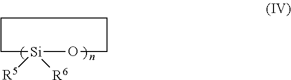

where R⁵ and R⁶ and are the same as described above. Specific examples include but are not limited to hexamethylcyclotrisiloxane, octamethylcyclotetrasiloxane, decamethylcyclopentasiloxane and dodecamethylcyclohexasiloxane, and to mixtures of cyclosiloxanes of different ring sizes.

The preferred ratio of silalactone to cyclosiloxane is 20:1 to 1:1, particular preference being given to a ratio of 10:1 to 1:1, very particular preference to a ratio of 3:1 to 1:1.

In one embodiment of the present disclosure the spacer group comprises one or more unit selected from —C(═O)-NR- where R represents a saturated or unsaturated organic radical which may contain one or more heteroatoms, preferably selected—independently of one another—from the group consisting of O, N, S and Si; preferably R3 is an alkyl and more preferably R3 is —CH₃. Such polymers can be prepared, for example, by methods as described, in WO2021/009154 A1 (Steinhauser). Typically, the polymers have at least one functional group according to the general structure of formula (V):

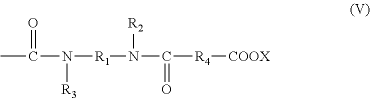

where
COOX represents a carboxylic acid group or a salt thereof. In case of a carboxylic acid group X represents H. In case of a salt thereof X represents an organic or inorganic cation, including but not limited to cations of is a Li, Na, K, Mg, Ca, Zn, Fe, Co, Ni, Al, Nd, Ti, Sn, Si, Zr, V, Mo or W.

R₂, R₃ are identical or different and represent saturated or unsaturated organic radicals with 1 to 40 carbon atoms and which may contain one or more heteroatoms, preferably selected—independently of one another—from the group consisting of O, N, S and Si; preferably R2 or R3 or both are —CH₃; and

R₁, R₄ are identical or different and represent saturated or unsaturated divalent organic radicals with 1 to 40 carbon atoms and which, in addition to C and H, may contain one or more heteroatoms preferably selected, independently of one another, from the group consisting of O, N, S and Si.

Preferably R₁ is a C₁-C₆-alkylene or heteroalkylene which may be saturated or unsaturated and which may, optionally, be substituted with one or more substituents, or a 6-14-membered arylene, which may be, optionally substituted with one or more substituents comprising independently of one another —F, —Cl, —Br, —I, —CN, ═O, —CF₃, -C₁-C₁₈-alkyl or -heteroalkyl, preferably C₁-C₁₈-fluoro- or chloroalkyl, more preferably —CF₃, —CF₂H, —CFH₂, —CF₂Cl, —CFCl₂.

Preferably R₂ and R₃ are independently from each other a -C₁-C₂₄-alkyl or -heteroalkyl, which may be unsaturated and preferably are saturated; a 6-24-membered aryl, a 5-24-membered heteroaryl, a 3-24-membered cycloalkyl which may be unsaturated and preferably are saturated, a 3-24-membered heterocycloalkyl, which may be unsaturated and preferably is saturated, and wherein in each case R2 may be substituted by one or more than one substituents comprising independently of one another —F, —Cl, —Br, —I, —CN, ═O, —CF₃, -C₁-C₁₈-alkyl or -heteroalkyl, preferably C₁-C₁₈-fluoro- or chloroalkyl, more preferably —CF₃, —CF₂H, —CFH₂, —CF₂Cl, —CFCl₂.

Preferably R₄ is a C₁-C₆-alkylene- or -heteroalkylene, which may be saturated or unsaturated; a 6-14-membered arylene, wherein in each case R₄ may be substituted by one or more substituents comprising independently of one another —F, —Cl, —Br, —I, —CN, ═O, —CF₃, -C₁-C₁₈-alkyl or -heteroalkyl, preferably C₁-C₁₈-fluoro- or chloroalkyl, more preferably —CF₃, —CF₂H, —CFH₂, —CF₂Cl, —CFCl₂

In a particular embodiment of formula (V) R₁ is a C₁-C₃-alkylene-, preferably —CH₂CH₂—; R₂ is a C₁-C₂-alkyl preferably —CH₃; R₃ is a C₁-C₂-alkyl, preferably —CH₃; and R₄ is selected from—CH₂-CHCₖH₂ₖ₊₁- wherein k is an integer of from 8 to 16; —CH₂CH((CH₂)₁₋₅Si(OC₁-C₄-alkyl)₃); —CH═C(C₁-C₄-alkyl), and —(CH₂)₂₋₄—; more preferably R₄ is selected from —CH₂—CHC₁₂H₂₃, —CH₂CH(CH₂CH₂CH₂Si(OCH₃)₃), —CH═CCH₃—, and —CH₂CH₂—CH₂—.

Preferably the spacer group Rx has a molecular weight of less than 5,000 g/mol, less than 2,000 g/mol, more preferably less than 1,000 g/mol.

### Polymer Compositions and Process of Making Polymer Compositions

It has been found that adding an or more organic acid to a diene rubber having functional units comprising at least one carboxylic acid group or salt thereof can stabilize the Mooney viscosity of such rubbers. The addition can be made to polymer solutions or to solid polymers. Adding the organic acid to polymer solutions can also reduce the solution viscosity and may facilitate the work up of the polymers because.

The organic acids can be combined with the solid polymers or polymer formulations by means as known to the person skilled in the art of rubber compounding. In one embodiment the acids are added to the polymers or polymer compositions by milling. Therefore, on one embodiment of the present disclosure the polymer composition according to the present disclosure is a solid composition. In one embodiment of the present disclosure the organic acids are added to polymer solutions. In one embodiment of the present disclosure the polymer composition according to the present disclosure is a liquid composition.

Therefore, in one aspect of the present disclosure there is provided a process comprising adding an organic acid according to the present disclosure to a first polymer according to the present disclosure wherein the first polymer is present either a) in solution in the presence of at least one solvent or b) in solid form, and wherein in case of a) the process may further comprise removing the solvent. Preferably, they are added to reaction mixtures containing the functionalized rubbers after the polymers have been functionalized and prior to the work up of the rubbers, for example, prior to washing or prior to drying the rubbers and preferably prior to solvent removal. The solvent can be removed from the reaction mixture by conventional methods including distillation, stripping with steam or by applying a vacuum or reduced pressure, if necessary, at elevated temperatures. The resulting polymer crumbs can be further dried on mills or processed on mills and formed, for example into sheets, or compressed, for example, into bales.

In one embodiment of the present disclosure there is provided a process comprising (i) polymerizing one more monomers to provide a diene polymer, preferably by solution polymerization, more preferably anionic solution polymerization; (ii) functionalizing the diene polymer to provide the first functionalized diene polymer according to the present disclosure having functional units containing at least one carboxylic acid group or salt thereof, (iii) adding at least one organic acid according to the present disclosure to the reaction mixture, optionally, (iv) adding one or more extender oil to provide an oil-extended first polymer, optionally, (v) adding at least one second polymer, (vi) removing the solvent. The resulting the polymer composition may be subjected to washing, drying, and shaping, for example shaping by milling into sheets or compression into bales. The functionalization may comprise the addition of a first and a second functionalization agent. Preferably the polymerization reaction is terminated by the addition of at least one functionalization agent, for example by providing an end group functionalized polymer.

It is known to add organic acids, in particular fatty acids, as plasticizers to rubber compounds to facilitate processing of the rubber compounds. Rubber compounds are mixtures of at least one rubbers and one or more fillers and, typically, one or more curing agent. Contrary to the known use as plasticizers in rubber compounding and processing, according to the present disclosure the organic acids are added to the first polymers to reduce and stabilize the Mooney viscosity of these polymers, to reduce the solution viscosity of polymer solutions comprising the first functionalized polymer according to the present disclosure and/or to provide polymer compositions with stabilized Mooney viscosities. These polymer compositions can be used as a raw material for making rubber compounds but the polymer compositions themselves are not rubber compounds. In one embodiment of the present disclosure consists essentially only of first polymer and organic acid. In case of polymer solutions, the polymer composition according to the present disclosure consists essentially only of first polymer, organic acid and at least one solvent. In case of blends the composition may also contain at least one second polymer. In case the first or the second polymer are oil-extended, the polymer compositions may also contain extender oil as part of the polymer. Consisting essentially as used herein shall mean the composition only has the ingredients as listed but may contain impurities. Impurities are other materials that were present in the raw materials or are residues from the manufacture or work up and include stabilizers. Typically, the total amounts of such residues and stabilizers are less than 5% by weight based on the total weight of the composition, preferably less than 1% by weight.

In one embodiment of the present disclosure the polymer composition according to the present disclosure comprises at least 90% by weight, preferably at least 95% by weight of polymer, which, optionally, in addition to the at least one first polymer according to the present disclosure may include at least one second polymer. Preferably, the amount of the at least one first polymer is at least 10% by weight, preferably at least 20% or at least 50% by weight and more preferably at least 75% by weight or at least 90% by weight or even at least 95% by weight. Preferably, such a composition is a solid composition. Such compositions may be obtained, for example, by mixing an adding organic acid with a solid polymer composition or by adding organic acid to a polymer solution, preferably a reaction mixture and removing the solvent. The amount expressed in % by weight include the amount of extender oil, if the first polymer or the second polymer or both are oil-extended.

The polymer composition may also contain one or more second polymers, for example in case the composition is a polymer blend, but the presence of any second polymer is optional. The second polymer may be the same polymer as the first polymer as far as monomer composition, molecular weight and molecular weight distribution are concerned, or it may be different, but the second polymer does not contain any functionalized groups, or it contains functionalized groups but not the functionalized groups like the first polymer. Preferably, the second polymer is a diene polymer, which may or may not be hydrogenated. Typical diene polymers include but are not limited to polymers comprising at least one of polybutadiene, polyisoprene, butadiene-isoprene copolymer, butadiene-styrene copolymer, isoprene-styrene copolymer, and butadiene-isoprene-styrene terpolymer. The polymers may have a mean molar masses (number-average, Mₙ) of 100,000 to 1,000,000 g/mol, and glass transition temperatures of −110° C. to 0° C. In one embodiment the composition comprises up to 50% by weight of second polymer, preferably the polymer composition comprises no second polymer or less than 1% by weight of second polymer.

In one embodiment the polymer composition of the present disclosure is a polymer solution, for example a solution obtained when adding an organic acid according to the present disclosure to a polymer solution containing the first polymer for reducing the solution viscosity. Such polymer solution includes a reaction mixture for example the reaction mixture from the polymerization reaction. Preferably such polymer composition according to the present disclosure has a total amount of first and optional second polymer of at least 10% by weight or at least 15% by weight based on the total weight of the composition which is 100% and wherein the amount of solvent is at least 50% by weight or at least 75% by weight based on the polymer composition. Preferably, the solvent comprises a polymerization solvent as described above or a combination thereof.

The presence of a second polymer is optional and the polymer composition according to the present disclosure may not contain any second polymer.

The first polymer or the second polymer or both may be oil-extended and may contain up to 100 parts per 100 parts of first or second polymer of extender oil depending on which polymer is oil-extended. In case the polymers are oil-extended, i.e. the polymers have been combined with one or more extender oil prior or during work up of the polymer, typically before solvent removal, the composition also contains extender-oil as part of the oil-extended polymers. Polymers may be oil-extended when they have a high molecular weight. Polymers with high molecular weight have high Mooney viscosities. When the Mooney viscosity is too high, processing the polymers for making rubber compounds may become difficult or uneconomic. The Money viscosity of the polymers can be reduced by adding extender oils prior or during the work up of the polymers to provide oil-extended polymers. Typical amounts of extender oils are from 10 to 100 parts per 100 parts of polymer. In one embodiment of the present disclosure the first and the second polymer are not oil-extended. The polymer composition preferably is essentially free of extender oil and contains no intentionally added extender oil. Such a composition contains less than 1 phr, preferably less than 0.1 phr and more preferably no extender oil. Extender oils include oils as known and used for the oil-extension of diene rubbers and include oils such as TDAE (Treated Distillate Aromatic Extract)-, MES (Mild Extraction Solvates)-, RAE (Residual Aromatic Extract)-, TRAE (Treated Residual Aromatic Extract)-, naphthenic oil, paraffinic oils and hydrogenated versions thereof including oils obtained from plant-based materials including terpenes. They are preferably added to the reaction mixture prior or during solvent removal.

Therefore, in the polymer composition of the present disclosure the first or the second polymer or both may contain from 0 to 100 parts of extender oil per 100 parts of polymer and wherein the amount of polymer indicated in the polymer compositions by weight percent includes the amount of extender oil when present.

The polymer compositions according to the present disclosure do not contain any added fillers and are therefore essentially free of any fillers, i.e., such compositions do not contain any carbon or silica-based fillers or filler that are neither based on carbon or silica. “Essentially free” as used herein means less than 5% by weight, preferably less than 1% by weight or even less than 0.1% by weight based on the total weight of the composition and including 0%. Such amounts may be the result of impurities present in the materials used or generated during the work-up procedure. The polymer composition according to the present disclosure do not contain any added curing agents and are essentially free of any curing agent and contain no curing agent or only residual amounts that may be present as impurities in the raw materials or materials used during work-up.

The polymer compositions according to the present disclosure can be obtained, for example, by the processes described above

### Rubber Compounds

The polymer compositions comprising the first polymer and the organic acid according to the present disclosure can be used to make rubber compounds by a process comprising combining the polymer compositions with one or more filler. Vulcanizable rubber compounds can be made by combining the polymer composition of the present disclosure with one or more filler and one or more cross-linking agent for cross-linking at least the first polymer.

The rubber compounds are suitable for making tires or components of tires such as sidewalls or tire treads. The vulcanizable rubber compounds according to the present disclosure contain one or more curing agent or curing system for cross-linking the end-group functionalized polymer according to the present disclosure and, optionally, other cross-linkable fillers or components. The resulting tire or tire component will typically contain the rubber compound in vulcanized form.

Therefore, in one aspect of the present disclosure there is provided a process of making a rubber compound comprising combining a polymer composition according to the present disclosure with at least one filler, at least one curing agent capable of curing the at least first polymer or a combination thereof.

The one or more filler and include both active and inactive fillers. Conventional fillers include silicas, silicates and, preferably, one or more than one carbon-based fillers, for example carbon blacks.

Examples of suitable silicas include but are not limited to: highly disperse silicas, including those produced by precipitation of solutions of silicates or flame hydrolysis of silicon halides with specific surfaces of 5-1000, preferably 20-400 m²/g (BET surface) and primary particle sizes of 10-400 nm. Silicas may also be present as mixed oxides with other metal oxides such as Al, Mg, Ca, Ba, Zn, Zr, Ti oxides; synthetic silicates including aluminum silicates, alkaline earth silicates including magnesium silicates or calcium silicates or combinations thereof, preferably having BET surfaces of 20-400 m²/g and primary particle diameters of 10-400 nm; natural silicates including kaolin and montmorillonite.

Examples of suitable fillers that are neither silicas nor carbon-based include but are not limited to glass fibers and glass fiber products (mats, strands) or microspheres; metal oxides including zinc oxide, calcium oxide, magnesium oxide, aluminum oxide; metal carbonates including magnesium carbonate, calcium carbonate, zinc carbonate; metal hydroxides including aluminum hydroxide, magnesium hydroxide; metal sulfates including calcium sulfate, barium sulfate; rubber gels including those based on BR, E-SBR and/or polychloroprene, preferably with particle sizes from 5 to 1000 nm.

Examples of suitable carbon-based fillers include but are not limited to carbon blacks produced by the flame soot, channel, furnace, gas soot, thermal, acetylene soot or arc process. The carbon-based fillers may have BET surfaces of 9-200 m²/g. Examples of specific carbon blacks include but are not limited to SAF-, ISAF-LS-, ISAF-HM-, ISAF-LM-, ISAF-HS-, CF-, SCF-, HAF-LS-, HAF-, HAF-HS-, FF-HS-, SPF-, XCF-, FEF-LS-, FEF-, FEF-HS-, GPF-HS-, GPF-, APF-, SRF-LS-, SRF-LM-, SRF-HS-, SRF-HM- and MT- soot or according to ASTM N110-, N219-, N220-, N231-, N234-, N242-, N294-, N326-, N327-, N330-, N332-, N339-, N347-, N351-, N356, N358, N375, N472, N539, N550, N568, N650, N660, N754, N762, N765, N774, N787 and N990 carbon blacks.

Preferably, the rubber compounds of the present disclosure contain one or more carbon blacks as fillers.

The fillers can be used alone or in a mixture. In a particularly preferred form, the rubber compositions contain a mixture of silica fillers, such as highly dispersed silicas, and carbon black. The weight ratio of silica fillers to carbon black may be from 0.01:1 to 50:1, preferably from 0.05:1 to 20:1.

The fillers may be used in quantities ranging from 10 to 500, preferably from 20 to 200 parts by weight based on 100 parts by weight of rubber.

The rubber compounds and the vulcanizable rubber compounds may further contain one or more additional rubbers other than the functionalized rubbers according to the present disclosure and one or more than one rubber additive.

Additional rubbers include, for example, natural rubber and synthetic rubber. If present, they may be used in amounts in the range from 0.5 to 95% by weight, preferably in the range from 10 to 80% by weight, based on the total amount of rubber in the composition. Examples of suitable synthetic rubbers include BR (polybutadiene), acrylic acid alkyl ester copolymers, IR (polyisoprene), E-SBR (styrene-butadiene copolymers produced by emulsion polymerization), S-SBR (styrene-butadiene copolymers produced by solution polymerization), IIR (isobutylene-isoprene copolymers), NBR (butadiene-acrylonitrile copolymers), HNBR (partially or completely hydrogenated NBR rubber), EPDM (ethylene-propylene-diene terpolymers) and mixtures thereof. Natural rubber, E-SBR and S-SBR with a glass temperature above −60° C., polybutadiene rubber with a high cis content (>90%) produced with catalysts based on Ni, Co, Ti or Nd, polybutadiene rubber with a vinyl content of up to 80% and mixtures thereof are of particular interest for the manufacture of automotive tires.

Rubber additives are ingredients that may improve the processing properties of the rubber compositions, serve to crosslink the rubber compositions, improve the physical properties of the vulcanizates produced from the rubber, improve the interaction between the rubber and the filler or serve to bond the rubber to the filler. Rubber auxiliaries include crosslinking agents such as sulfur or sulfur-supplying compounds, reaction accelerators, antioxidants, heat stabilizers, light stabilizers, ozone stabilizers, processing aids, plasticizers, tackifiers, blowing agents, dyes, pigments, waxes, extenders, organic acids, silanes, retarders, metal oxides, extender oils such as DAE (Distillate Aromatic Extract)-, TDAE (Treated Distillate Aromatic Extract)-, MES (Mild Extraction Solvates)-, RAE (Residual Aromatic Extract)-, TRAE (Treated Residual Aromatic Extract)-, naphthenic and heavy naphthenic oils as well as activators.

The total amount of rubber additives may range from 1 to 300 parts by weight, preferably from 5 to 150 parts by weight based on 100 parts by weight of total rubber in the composition.

The rubber compositions can be prepared with conventional processing equipment for making and processing of (vulcanizable) rubber compounds and include rollers, kneaders, internal mixers or mixing extruders. The rubber compositions can be produced in a single-stage or a multi-stage process, with 2 to 3 mixing stages being preferred. Cross-linking agents, for example sulfur, and accelerators may be added in a separate mixing stage, for example on a roller, with temperatures in the range of 30° C. to 90° C. being preferred. Cross-linking agent, for example sulfur, and accelerator are preferably added in the final mixing stage.

Examples of typical formulations of rubber compounds include those shown in US2016/0075809 A1 and US2016/0083495 A1 (Steinhauser and Gross) and in international patent application WO2021/009154 (Steinhauser).

### Applications

The rubber compounds containing the polymer compositions according to the present disclosure can be used for producing rubber vulcanizates, preferably for producing tires, in particular tire treads. Therefore, in one aspect there is provided an article obtained from curing a composition comprising the rubber compound obtained in the process according to the present disclosure for making rubber compounds.

The rubber compounds containing the polymer compositions provided herein are also suitable for the manufacture of molded articles, for example for the manufacture of cable sheaths, hoses, drive belts, conveyor belts, roll linings, shoe soles, sealing rings and damping elements.

Another aspect of the present disclosure relates to a molded article, in particular a tire, containing a vulcanized rubber composition obtained by vulcanizing the vulcanizable rubber compositions provided according to the present disclosure.

### EXAMPLES

The following examples are provided to further illustrate the present disclosure without, however, intending to limit the disclosure to the embodiments set forth in these examples.

### Polymer Data

The number-average molecular weight Mn, the weight-averaged molecular weight (Mw), the polydispersity Ð=Mw/Mn, also referred to as “PDI” were determined using gel permeation chromatography (GPC) at 35° C. (polystyrene calibration).

The Mooney viscosity of the polymer was measured according to DIN ISO 289-1 (2018) at the measuring conditions ML(1+4) at 100° C.

The solution viscosity was determined by a Brookfield viscometer.

The vinyl and styrene content can be determined by FTIR spectroscopy on rubber films.

The content of organic acids in the polymer composition can be determined by GC-MS (gas chromatography coupled with mass spectrometry). The GC-MS may be equipped with a flame ionization detector (FID) for the quantification of the components and with a mass spectrometry detector (MSD) for the identification of the components. For the analysis a sample of the polymer composition (typically 1 g) can be dissolved in an appropriate solvent, typically tetrahydrofurane (THF), for example in 30 ml of THF. Then the solution can be precipitated with methanol (typically 60 ml) and the supernatant is collected. The precipitate is washed with methanol and the washing solution is combined with the supernatant. The solvents (THF and methanol) are removed by evaporation. The residue is treated with an excess of silylating agent, for example (trimethylsilyl)trifluoroacetamide, about 10 ml)) and is then subjected to the GC-MS. If necessary, for example because no solution is obtained, the residue can be taken up (redissolved) in THF (or another appropriate solvent).

### Examples 1a-1d (Comparative) and Examples 1e-1j

In an inert 20 L reactor filled with 8500 g hexane, 1500 g 1,3-butadiene and 10.5 mmol n-butyllithium (as a 23 wt. % solution in hexane) were stirred at 70° C. for 45 min. For making comparative examples 1a-1c 1500 g polymer solution was taken from the reactor and quenched with 1.58 mmol n-octanol. The polymer solution was divided into 3 samples and stearic acid was added to two samples according to Table 1 (comparative examples 1a-1c). The solution viscosity was determined using a Brookfield viscometer, and the samples were precipitated in ethanol and dried in a vacuum oven at 65° C. The Mooney viscosity ML1+4@100° C. of the final samples was determined.

For making the functionalized polymers with functional units having a carboxylic acid group and a spacer comprising units according to formula (IIA) and (IIB) the teaching of US2016/0075809 A1 (incorporated herein by reference, in particular its experimental section) was followed. Functionalized 5.25 mmol 2,2-bis(2-tetrahydrofuryl)-propane was added as randomizer to the remaining living polymer solution and the solution was stirred at 70° C. for 5 minutes. Then 10.5 mmol of a cyclosiloxane according to formula (IV) was added as first functionalization reagent over 15 minutes at 70° C. The solution was stirred at 70° C. for 15 minutes and then an equimolar amount of a silolactone according to formula (III) was added as second functionalization reagent. After the addition of the second functionalization reagent was completed the polymer solution containing the polymer functionalized with end groups having a carboxylic acid group was continued to be stirred at 70° C. for another 30 minutes. The polymer solution was drained and stabilized by adding 4.5 g Irganox® 1520 (2,4-bis(octylthiomethyl)-6-methylphenol). This polymer solution was divided into seven samples (1d-1j). Different organic acids were added to samples 1e to 1j but not to 1d which was used as comparison. The solution viscosity before and after the addition of the organic acids was determined using a Brookfield viscometer. Subsequently, the samples were precipitated in ethanol and dried in a vacuum oven at 65° C. All samples were characterized by size exclusion chromatography (SEC) and Mooney viscosities ML1+4@100° C. The results are shown in table 1

TABLE 1
Summary of experimental results from examples 1a-1j.

| | | Amount | Solution | | | |
|---|---|---|---|---|---|---|
| | Carboxylic | carboxylic | viscosity/ | ML(1 + 4)@100° | Mₙ/g | |
| Example | acid | acid/phr | mPa s | C./MU | mol⁻¹ | PDI |
| 1a | — | 0 | 328 | 42.6 | 330181 | 1.20 |
| (comparative) | | | | | | |
| 1b | stearic | 1 | 303 | 39.9 | 330374 | 1.19 |
| (comparative) | acid | | | | | |
| 1c | stearic | 2 | 306 | 41.7 | 327204 | 1.20 |
| (comparative) | acid | | | | | |
| 1d | — | 0 | 850 | 63.6 | 318686 | 1.15 |
| (comparative) | | | | | | |
| 1e | stearic | 1 | 205 | 37.8 | 320395 | 1.22 |
| (inventive) | acid | | | | | |
| 1f | stearic | 2 | 204 | 36.2 | 314757 | 1.18 |
| (inventive) | acid | | | | | |
| 1g | versatic | 1 | 243 | 40.2 | 326211 | 1.22 |
| (inventive) | acid | | | | | |
| 1h | versatic | 2 | 215 | 39.9 | 321709 | 1.21 |
| (inventive) | acid | | | | | |
| 1i | adipic | 1 | 700 | 38.2 | 322697 | 1.20 |
| (inventive) | acid | | | | | |
| 1j | adipic | 2 | 598 | 36.8 | 318305 | 1.17 |
| (inventive) | acid | | | | | |

Results for examples 1a-1c: The addition of the organic acid slightly reduced the solution viscosity (reduction by less than 10%) which can be attributed to a plasticizing effect of the acid. The Mooney viscosity of the polymers remained approximately the same. The polymer of examples 1a-1c was not functionalized.

Results for examples 1d and 1e-1j: The addition of organic acids om examples 1e-1j led to a significant reduction of the solution viscosity of the functionalized polymers (reduction of >10%). The functionalized polymers obtained after polymerization hade a higher Mooney viscosity than their non-functionalized counterparts (as can be seen for example by a comparison of 1a with 1d). This is believed to be caused by the association of the functional groups. However, this increased Mooney viscosity was not stable over time but got reduced upon storage to a similar value of its non-functionalized counterpart. The addition of the organic acids to the functionalized polymers (examples 1e-1j) reduced their Mooney viscosity closely to that of the non-functionalized counterpart, which is believed to be the “correct” value for the polymer, and this value remains stable upon storage.

### Examples 2a (Comparative), 2b and 2c

A polymer was prepared as described in example 1 for sample 1d). The polymer solution was divided into three samples (2a-2c) and organic acids were added to two of these samples while no acid was added to the other sample as shown in Table 2. Subsequently, the samples were precipitated in ethanol and dried in a vacuum oven at 65° C. The Mooney viscosities ML1+4@100° C. were determined after the samples were dried, after 29 days and after 132 days. The results are shown in Table 2.

TABLE 2
Summary of experimental results from examples 2a-c.

| | Stearic acid | Time after | |
|---|---|---|---|
| Example | content/phr | production/d | ML(1 + 4)@100° C./MU |
| 2a (comparative) | — | 0 | 135.4 |
| | — | 29 | 103.4 |
| | — | 132 | 76.6 |
| 2b (inventive) | 0.2 | 0 | 50.9 |
| | 0.2 | 29 | 47.1 |
| | 0.2 | 132 | 48.5 |
| 2c (inventive) | 1 | 0 | 44.5 |
| | 1 | 29 | 44 |
| | 1 | 132 | 45.5 |

Example 2a shows the instability of the Mooney viscosity upon storage for diene polymers having functional groups with a carboxylic acid. Without addition of organic acid to stabilize the polymer composition the Mooney viscosity reduces over time by almost 50% of the value it had after preparation. Addition of the organic acid stabilized the Mooney viscosity of the samples. The values obtained upon storage remained similar to those obtained directly after the preparation of the polymer (examples 2b and 2c).

### Example 3: Addition of Organic Acids to Solid Polymers

Butadiene-styrene copolymer samples of similar microstructure and molecular weight distribution, one containing no functional units with carboxylate groups and the other one containing carboxylate groups, were used for examples 3a-3d. 3a and 3b contained functionalized end groups obtained by anionic reaction with a cyclosiloxane according to formula (IV). The end-group functionalized polymer had functional polar end groups but not according to the claimed polymers (not having a carboxylic acid group or salt thereof) and are comparative examples. Polymers 3c and 3d were prepared by sequential reaction of polymer chain with a cyclosiloxane and a silalactone according to the teaching of US2016/0075809 A1 and contained a functional unit having a carboxylic acid group. All polymers 3a-3d and contained 5 phr of extender oil.

Stearic acid was incorporated into the polymers 3b (comparative) and 3d on a two-roll mill and the Mooney viscosities ML1+4@100° C. of the resulting polymer compositions were determined. No organic acid was added to samples 3a and sample 3c (both examples are comparative) and both samples had significantly different ML1+4@100° C. values with a strong increase of the carboxylic acid group containing polymer 3c. The addition of stearic acid to the polymers 3b and 3d reduced the Mooney viscosity such that both polymers had about the same ML1+4@100° C. values.

TABLE 3
Summary of experimental results from examples 3a-d.

| | | | | Amount | | | |
|---|---|---|---|---|---|---|---|
| | | | Carboxylic | stearic | | | ML(1 + 4) |
| | Styrene | Vinyl | acid | acid | Mₙ/g | | @100° C. |
| Example | [wt %] | [wt %] | groups | [phr] | mol⁻¹ | PDI | [MU] |
| 3a | 32 | 11 | No | 0 | 283,000 | 2.19 | 69.9 |
| 3b | 32 | 11 | No | 1 | — | — | 66.4 |
| 3c | 32 | 11 | Yes | 0 | 289,000 | 2.18 | 78.6 |
| 3d | 32 | 11 | Yes | 1 | — | — | 66.4 |

### Example 4

Experiments similar to Examples 1a to 1j were repeated with a polybutadiene (LiBR) having end groups according to formula (V). The polymer was prepared as described in international patent application WO2021/009154 A1 (Steinhauser), incorporated herein by reference, in particular its experimental section. The introduction of the functional units to the reaction mixture led to an increase in solution viscosity from 430 mPa s to 620 mPas but the molecular weight distribution determined by SEC did not change upon functionalization. Adding stearic acid to the polymer solution led to a decrease of the solution viscosity to 466 mPas.

1. A polymer composition comprising
(i) at least one first polymer wherein the first polymer is a functionalized diene polymer comprising at least one functional unit having at least one carboxylic acid group or a salt thereof, wherein the functional unit is selected from terminal groups, side groups and combinations thereof;
(ii) at least one organic acid according to the general formula (1):
Ry-(Acg)ₙ (1),
(iii), optionally, at least one second polymer,
wherein the polymer composition has a total amount of the first and optional second polymer of at least 90% by weight, based on a total weight of the composition which is 100% and wherein the amount of the at least one first polymer is at least 10% by weight, and wherein the first or the second polymer or both contain from 0 to 100 parts of extender oil per 100 parts of polymer and wherein the amount of polymer indicated by weight percent includes the amount of extender oil if present, and wherein in formula (1)
Acg represents an acid group selected from —COOH, —SO₃H, —OSO₃H, —PO₃H₂, —OPO₃H₂ and salts thereof and combinations thereof;
n represents an integer from 1 to 10.000;
Ry represents an aromatic or aliphatic, saturated, linear, cyclic or branched hydrocarbon or heterohydrocarbon residue having a valency corresponding to n, wherein the heterohydrocarbon residue is a hydrocarbon residue that comprises additionally one or more heteroatoms selected from N, S, Si, O, F, Cl, Br and combinations thereof, and, in case Acg is COOH, Ry can also represent H,
and wherein the first functionalized diene polymer is a homopolymer of a conjugated diene or a copolymer of at least one conjugated diene and wherein the conjugated diene is selected from butadiene.

2. The polymer composition according to claim 1 wherein the functional unit of the first polymers corresponds to formula (2):
-Rx-COOX (2)
wherein -COOX represents a carboxylic acid group or a salt thereof and Rx represents a spacer group connecting the COOX group and the polymer, wherein the spacer group is a chemical bond or comprises at least one group selected from silane, polysilane, siloxane, polysiloxane, —C(═O)-NR-, where R represents a saturated or unsaturated organic radical with 1 to 40 carbon atoms and which may contain one or more heteroatoms selected, independently of one another, from the group consisting of O, N, S and and Si, and combinations thereof.

3. The polymer composition according to claim 1 wherein the spacer group Rx comprises at least one group selected from formula (2A): 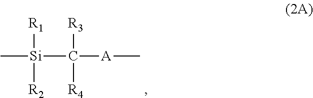 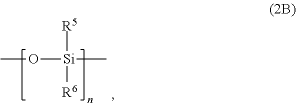
or a combination thereof, where in formula (2A) and (2B)
R¹, R² are the same or different and are each selected from H or a residue having from 1 to 20 carbon atoms;
R³, R⁴ are the same or different and are each selected from H or a residue having from 1 to 20 carbon atoms,
R⁵, R⁶ are the same or different and are each selected from H, or a residue having from 1 to 20 carbon atoms,
A is a divalent organic radical having from 1 to 26 carbon atoms, and which may, in addition to hydrogen atoms, comprise heteroatoms selected from O, N, S, and Si, and
n is an integer of 1 to 20;
or the functional group corresponds to formula (V): 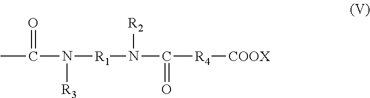
where COOX represents a carboxylic acid group or a salt thereof;
R₂, R₃ are identical or different and represent saturated or unsaturated organic radicals with 1 to 40 carbon atoms and which optionally contain one or more heteroatoms selected, independently of one another, from from the group consisting of O, N, S and Si; and
R₁, R₄ are identical or different and represent saturated or unsaturated divalent organic radicals with 1 to 40 carbon atoms and which, in addition to C and H, optionally contain one or more heteroatoms selected, independently of one another, from the group consisting of O, N, S and Si.

4. The polymer composition according to claim 1 wherein the functionalized diene polymer is a copolymer comprising units derived from at least one other conjugated diene, at least one vinylaromatic comonomer or combinations thereof, wherein the vinyl aromatic comonomer is selected from styrene, ortho-methyl styrene, meta-methyl styrene, para-methyl styrene, para-tertbutyl styrene, vinyl naphthalene, divinyl benzene, trivinyl benzene, and divinyl naphthalene, and combinations thereof.

5. The polymer composition according to claim 1 wherein the composition comprises at least 95% by weight of the at least one first polymer.

6. The polymer composition according to claim 1 wherein the first or the optional second polymer, or both, are not oil-extended.

7. The polymer composition according to claim 1 wherein A represents a carboxylic acid group (—COOH group) or a salt thereof.

8. The polymer composition according to claim 1 wherein in formula (1) Ry represents a saturated, aliphatic hydrocarbon residue.

9. The polymer composition according to claim 1 wherein in formula (1) A represents a carboxylic acid group or a salt thereof and n represents an integer from 1 to 1,000.

10. The polymer composition according to claim 1 wherein Ry represents a residue having from 1 to 50 carbon atoms or the organic acid is formic acid or a salt thereof.

11. The polymer composition according to claim 1 comprising from 0.01% by weight to 10% by weight of the organic acid, based on the total weight of the composition.

12. The polymer composition according to claim 1 wherein the optional at least one second polymer is a homopolymer of a conjugated diene or a copolymer of at least one conjugated diene and wherein the at least conjugated diene is selected from the group consisting of butadiene, isoprene, 1,3-pentadiene, 2,3-dimethylbutadiene, 1-phenyl-1,3-butadiene, 1,3-hexadiene, myrcene, ocimenes, and farnesene, wherein the homopolymer or copolymer includes hydrogenated homo- and copolymers.

13. Process of producing a polymer composition according to claim 1, comprising adding the organic acid to the first polymer, wherein the first polymer is present either a) in solution in the presence of a solvent or b) in solid form, and wherein in case of a) the process, optionally, further comprises removing the solvent.

14. Process of making a rubber compound comprising combining the polymer composition according to claim 1 with at least one filler, at least one curing agent capable of curing the at least first polymer, or a combination thereof.

15. Article obtained from curing a composition comprising the rubber compound obtained in the process of claim 14.

16. The polymer composition according to claim 9, wherein n is 1, 2, 3, 4, 5, 6, 7, 8, 9, or 10.

17. The polymer composition according to claim 16, wherein n is 1 or 2.

18. The polymer composition according to claim 11, comprising from 0.1% to 9% by weight of the organic acid.

19. The polymer composition according to claim 18, comprising from 1.1% to 7.5% by weight of the organic acid.

20. Article according to claim 15, which is a tire or a component thereof.
